(19) United States
(12) Patent Application Publication
(10) Pub. No.: US 2025/0341305 A1
(43) Pub. Date: Nov. 6, 2025

(54) BEVERAGE CONTAINER LIGHTS

(71) Applicant: Adam M. Kulikowski, Boulder, CO (US)

(72) Inventor: Adam M. Kulikowski, Boulder, CO (US)

(21) Appl. No.: 19/199,262

(22) Filed: May 5, 2025

Related U.S. Application Data
(60) Provisional application No. 63/642,865, filed on May 5, 2024.

(51) Int. Cl. F21V 33/00; A47G 19/22; F21S 9/02; F21V 21/08; F21V 23/00; F21V 23/04; F21V 31/00; F21Y 113/13; F21Y 115/10

(52) U.S. Cl. CPC F21V 33/0036; A47G 19/2227; F21S 9/02; F21V 21/0808; F21V 23/005; F21V 23/0407; F21V 31/005; A47G 2019/2238; F21Y 2113/13; F21Y 2115/10

(57) ABSTRACT

A self-contained illumination device for illuminating liquid contents of a beverage container. A device is typically used on a container having a transparent sidewall. An exemplary device comprises a pad including a control circuit, a power source connectable to the control circuit, and a plurality of light sources connectable to the control circuit.

### RELATED APPLICATION

This application claims the benefit of U.S. Provisional Application Ser. No. 63/642,865, filed May 5, 2024, titled “Beverage Container Lights”.

### FIELD OF THE INVENTION

The present invention relates to lighting, and more specifically to illumination devices attachable to beverage containers.

### BACKGROUND OF THE INVENTION

Over the past several decades, numerous systems and devices for the ornamental lighting of beverage containers, particularly transparent beverage containers, have become available in the marketplace. For example, so-called LED bottle light-up coasters are readily found on the internet, such as on Amazon.com. These typically comprise a circular, adhesive foam pad having a circular, center recess containing small LED lights, electronic circuitry and one or more batteries. Such units are typically designed for placement and attachment in a concave bottom of a bottle. Generally, these lighting devices and systems possess features that make them impractical to use or limit their ornamental effects. Such unfavorable features include, for example, being bulky, being not self-contained, being limited to placement at the bottom or top of the container, being expensive to manufacture, being subject to liquid exposure and damage, and having a limited number of lighting units, of light colors, and of light display options, among other limitations. For example, U.S. Pat. No. 8,814,379, issued Aug. 26, 2014, to Griffiths et al. (Griffiths '379) discloses methods for manufacturing a ring-shaped illumination device for attachment to a container. The ring-shaped invention of Griffiths '379 is intended to be attached to the bottom of a beverage container, such as a beer bottle, having a recess at its bottom. As a result, Griffiths '379 is tightly constrained to devices having very thin overall thickness. U.S. Pat. No. 6,793,362, issued Sep. 21, 2004, to Tai (Tai '362), which is hereby incorporated by reference in its entirety, teaches an integrated circuit in a printed circuit board programmable to control a plurality of LEDs to effect multi-colored blinking lights through liquid in a container having translucent sidewalls. Similar to Griffiths '379, the device of Tai '362 is positioned at the bottom of the container.

Devices in accordance with the present invention help to solve some of the problems and limitations of the prior art.

### SUMMARY OF THE INVENTION

The invention provides devices, systems and methods for creating unique, multicolored lighting effects in and around the liquid contents of transparent beverage containers.

Features, characteristics and advantages of embodiments in accordance with the invention will become apparent from consideration of the description and drawings below.

### BRIEF DESCRIPTION OF DRAWINGS

A more complete understanding of the invention may be obtained by reference to the drawings, in which:

FIG. 1 depicts a self-contained illumination device attached in a substantially vertical orientation on a transparent sidewall of a beverage container;

FIG. 2 depicts a self-contained illumination device attached in a substantially horizontal orientation on a transparent sidewall of a beverage container;

FIG. 3 depicts a transparent sidewall of a beverage container having a convex recess in a substantially vertical orientation;

FIG. 4 depicts a self-contained illumination device attached in a substantially vertical orientation and retained in a convex recess of a transparent sidewall of a beverage container;

FIG. 5 depicts a self-contained illumination device attached in a substantially horizontal orientation and retained in a convex recess of a transparent sidewall of a beverage container;

FIG. 6 depicts schematically a sectional sideview of an illumination device having a removable protective film;

FIG. 7 depicts schematically a sectional sideview of an illumination device as in FIG. 6 after removable of the protective film;

FIG. 8 depicts schematically a top view of an embodiment of an illumination device;

FIG. 9 depicts schematically a top view of an illumination device having a bottom adhesive film that extends laterally from a portion of the pad periphery;

FIG. 10 depicts schematically a bottom view of an illumination device having a bottom adhesive film that extends laterally from substantially all of the pad periphery;

FIG. 11 depicts schematically a cross-sectional view of an embodiment of an illumination device in accordance with the invention;

FIG. 12 depicts schematically a cross-sectional view of an illumination device as in FIG. 11 after the protective film has been removed prior to adhesion of the illumination device onto a beverage container;

FIG. 13 depicts schematically a cross-sectional view of an illumination device in accordance with the invention;

FIG. 14 depicts schematically some of the principal components suitable for assembling an illumination device in accordance with the invention;

FIG. 15 depicts schematically an illumination device in accordance with the invention after a top cover film has been attached to cover the pad;

FIG. 16 depicts schematically a self-contained illumination device attached to a beverage container;

FIG. 17 depicts schematically principal components suitable for assembling an illumination device that comprises a top adhesive film, a pad, and a bottom cover film; and

FIG. 18 depicts schematically the illumination device as depicted in FIG. 17 after top adhesive film has been attached to the bottom cover film with the pad in between.

### DETAILED DESCRIPTION OF THE INVENTION

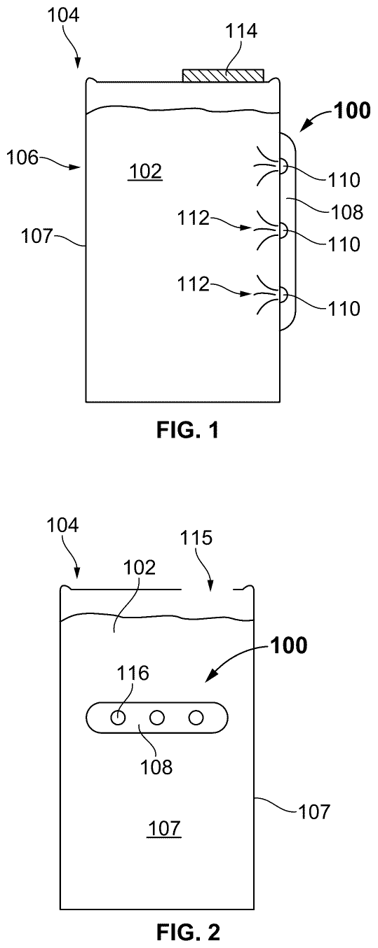

The invention is described herein with reference to FIGS. 1-18. It should be understood that these figures, depicting elements, systems and processes of embodiments in accordance with the invention, are not meant to be actual views or diagrams of any particular portion of an actual component, device or process. The figures instead show idealized representations that are employed to explain more clearly and fully the structures, materials and methods of the invention than would otherwise be possible. Also, the figures represent only one of innumerable variations of structures and systems that could be made or adapted to implement the invention. Devices and methods are described with numerous specific details in order to provide a thorough understanding of the present invention. It will be obvious to one skilled in the art that these specific details are not required to practice the present invention. It is clear that embodiments in accordance with the invention can be practiced using structures, devices and methods different from those described with reference to FIGS. 1-18. The preferred embodiments described herein are exemplary and are not intended to limit the scope of the invention.

For the sake of clarity, in some of the figures below, the same reference numeral is used to designate structures and components that are the same or are similar in the various embodiments described.

The word “translucent” in this specification includes its usual meaning to describe a substance that allows light to pass through it. In this specification, however, “translucent” also means “transparent”; that is, it also can refer to a substances that is substantially clear and allows light to pass through it so that objects can be distinctly seen through the substance.

The term “adhesive” in this specification means any type of adhesive or glue suitable for attaching an illumination device in accordance with the invention to a beverage container. For example, in some embodiments, an adhesive has the traits of adhesive contained on common first-aid bandage strips from which a non-sticking film is removed prior to use. In other exemplary embodiments, an adhesive is activated by moisture, such as a glue contained traditionally on old-style envelopes and postage stamps.

FIG. 1 depicts schematically a self-contained illumination device 100 for illuminating liquid contents 102 of a beverage container 104 having a substantially transparent sidewall 106 with an exterior sidewall surface 107. Illumination device 100 comprises a pad 108 and a plurality of light sources 110 integral in said pad 108. Light sources 110 are operable to shine light rays 112 to illuminate liquid 102 and create ornamental effects. Pad 108 is designed to be attachable to beverage container 104. In the design and manufacture of an illumination device 100 in accordance with the invention, its dimensions are influenced by its anticipated use on beverage containers of a given approximate size and shape. In the embodiment depicted in FIG. 1, illumination device 100 has an elongated shape and pad 108 has a length that is longer than its width. In some exemplary embodiments intended for use on typical beverage containers having a volume in a range of about from 0.5 liter to 1.0 liter, pad 108 has a length in a range of about from 2 centimeter (cm) to 10 cm, more typically in a range of about from 4 cm to 8 cm, and pad 108 has a corresponding width in a range of about from 0.3 cm to 5 cm, more typically in a range of about from 0.5 cm to 3 cm. In the embodiment depicted in FIG. 1, elongated pad 108 is attached to transparent sidewall 106 in a substantially vertical orientation relative to upright beverage container 104. Beverage containers suitable for use with the invention vary in volumetric capacity and shape. Preferably, a beverage container has a relatively smooth exterior sidewall surface 107, or at least a smooth portion of the sidewall surface, so that pad 108 attaches to form a good adhesive seal with exterior sidewall surface 107. A good adhesive seal inhibits intrusion of liquid that might otherwise intrude from the environment of the can. A good adhesive seal also inhibits leakage of light rays sideways from lights 110, away from their desired focus into the liquid contents 102. Of course, as the liquid level in a beverage container drops as beverage is consumed or otherwise removed, the lighting effects might become less dramatic, but they still persist. As depicted in FIG. 1, container 104 has the shape of a so-called pull-tab transparent beverage container having a pull-tab 114.

In preferred embodiments, illumination device 100 is flexible so that it can adhere well to curved surfaces, which are typical in beverage containers. Accordingly, pad 108 comprises flexible material.

FIG. 2 depicts a beverage container 104 in an opened state having an opening 115. As depicted in FIG. 2, pad 108 of illumination device 100 is attached to exterior sidewall surface 107 in a substantially horizontal orientation relative to upright beverage container 104. As depicted in FIG. 2, illumination device 100 comprises manually operable switching means 116 accessible on the exterior surface of pad 108 and operable to connect a power source (not shown here) to light sources 110 (FIG. 1). Preferred embodiments in accordance with the invention may be designed for attachment to a beverage container by one or more of consumers, manufacturers of beverage containers, and fillers of beverage containers.

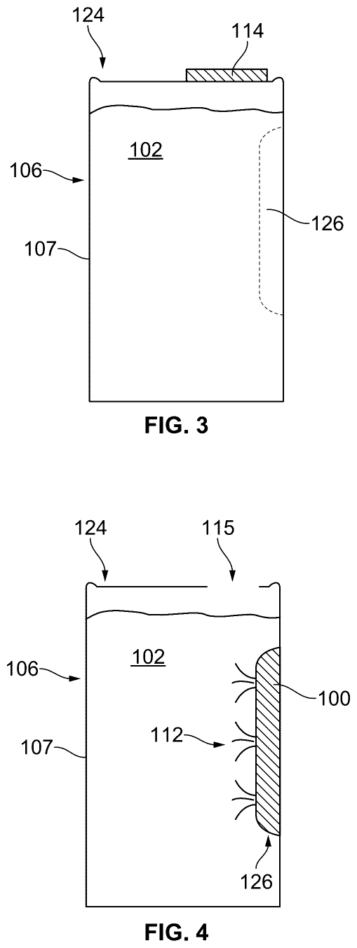

FIG. 3 depicts a beverage container 124 having a substantially transparent sidewall 106 with a convex recess 126 in sidewall 106. Convex recess 126 is shaped and sized to accommodate an illumination device in accordance with invention substantially within the recess.

FIG. 4 depicts a transparent beverage container 124 having convex recess 126 that substantially retains within the recess an illumination device 100 in accordance with the invention. As depicted in FIG. 4, the top surface of illumination device 100 is substantially flush with exterior sidewall surface 107 although in some applications, it may raise slightly above surface 107. The placement of an illumination device 100 within a convex recess has several advantages: it makes the illumination device visually more pleasing; it makes the combination of beverage container and illumination device easier and more comfortable to hold for the consumer; it makes the illumination device less exposed to damage by abrasion or pressure during shipment (e.g., if applied by a bottler) or during consumer usage; it offers more protection of the lights and the surface side of the pad against intrusion by water; it offers a better sealing of the light rays and their focus into the interior of the container.

As depicted in FIG. 4, convex recess 126 and illumination device 100 have a substantially vertical orientation relative to upright beverage container 124.

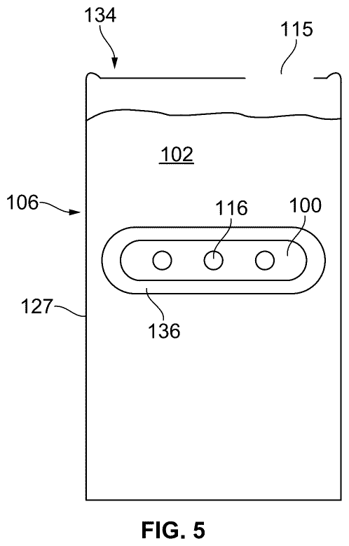

FIG. 5 depicts a transparent beverage container 134 having convex recess 136 that substantially retains within the recess an illumination device 100 in accordance with the invention. Convex recess 136 and illumination device 100 have a substantially vertical orientation relative to upright beverage container 134.

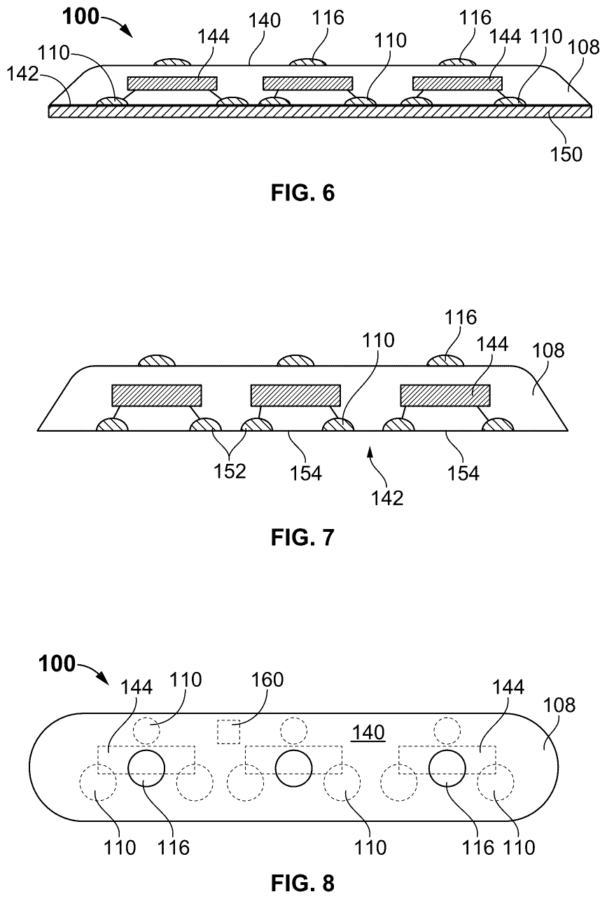

FIG. 6 depicts schematically a sectional sideview of an embodiment of an illumination device 100 in accordance with the invention. Device 100 comprises pad 108 containing flexible, liquid-resistant and/or liquid-proof material. Pad 108 has an exterior surface 140, an adhering surface 142, and a plurality of circuit regions 144 integral in pad 108. A circuit region 144 contains a control circuit, not shown here, for controlling a plurality of lights. In preferred embodiments, a control circuit is an integrated circuit in a printed circuit board. Device 100 further includes a plurality of light sources 110 connectable to said control circuits in control regions 144. Preferably, light sources 110 are LED lights. Some other embodiments, not shown here, comprise only a single control circuit connected to a plurality of light sources 110. A control circuit is operable to control light sources 110 to shine continuously, in a blinking or flashing manner, in varying activated colors, and with a combination of such effects. Device 100 further comprises a plurality of manually operable switching means 116 accessible on the exterior surface 140 of pad 108, each operable to connect electrically a control circuit in a circuit region 144, lights 110 and a power source (not shown here). Some other embodiments, not shown here, comprise only a single manually operable switching means 116 accessible on the exterior surface 140 of pad 108 operable to connect one or more control regions 140, a power source and a plurality of light sources 110. Illumination device 100 also includes a removable protective film 150 that protects adhering surface 142 before adhesion of said pad 108 onto a substantially transparent sidewall.

In preferred embodiments in accordance with the invention, pad 108 has a thickness in a range of about from 1.0 millimeter (mm) to 1 cm, more typically in a range of about from 2 mm to 5 mm.

U.S. Pat. No. 8,814,379, issued Aug. 26, 2014, to Griffiths et al. (hereinafter Griffiths '379), which is hereby incorporated by reference in its entirety, discloses methods for manufacturing a ring-shaped illumination device for attachment to a container. Methods resembling those disclosed in Griffiths '379 are adaptable for the manufacture of illumination devices in accordance with the present invention. The ring-shaped invention of Griffiths '379 is intended to be attached to the bottom of a beverage container, such as a beer bottle, having a recess at its bottom. As a result, Griffiths '379 is tightly constrained to devices having very thin overall thickness. Devices and methods of the current invention do not suffer such constraints because an illumination device 100 is designed and shaped typically to adhere to the sidewall of a beverage container.

FIG. 7 depicts schematically a sectional sideview of an embodiment of an illumination device 100 as in FIG. 6 except that removable protective film 150 has been removed to expose adhering surface 142. Adhering surface 142 includes a plurality of light areas 152 and an adhesive region 154 substantially surrounding said light areas 152. Pad 108 pad typically has a thickness in a range of about 0.1 mm to 1 cm, more typically in a range of about from 2 mm to 5 mm.

As depicted in FIGS. 6 and 7, switching means 116 comprises a domed tact switch, which is raised above exterior surface 140 of pad 108, typically in a range of about from 0.2 to 1 mm. In some embodiments, switching means is operable for single, one-time operation, corresponding to a one-time use of illumination device 100. In some embodiments, switching means is operable for numerous on-off switching. Griffiths '379 discloses a domed tact switch in a container illumination device.

Griffiths '379 discloses materials, structures and manufacturing methods of printed circuit boards for control circuits in circuit regions of container illumination devices. Griffiths '379 further discloses materials, structures and manufacture methods for: adhesive regions in pads; battery cells used as power sources; adhesive materials to attach devices to container surfaces; flexible pads; LED lights; electrical connections between lights; removable protective films.

FIG. 8 depicts schematically a top view of an embodiment of an illumination device 100 as in FIGS. 6 and 7. As depicted, illumination device 100 comprises a pad 108, an exterior surface 140, a power source 160 integral in pad 108, a plurality of control regions 144, and a plurality of LED light sources 110. Device 100 further includes manual switching means 116 for electrically connecting power source 160, control region 144 and light sources 110. A power source 110 is typically a small battery cell having sufficient voltage and current rating to power a plurality of LED lights for a period of at least about one-half hour.

U.S. Pat. No. 6,793,362, issued Sep. 21, 2004, to Tai, which is hereby incorporated by reference in its entirety, teaches an integrated circuit in a printed circuit board programmable to control a plurality of LEDs to effect multi-colored blinking lights through liquid in a container having translucent sidewalls. In contrast to the present invention, the device in Tai is positioned at the bottom of the container.

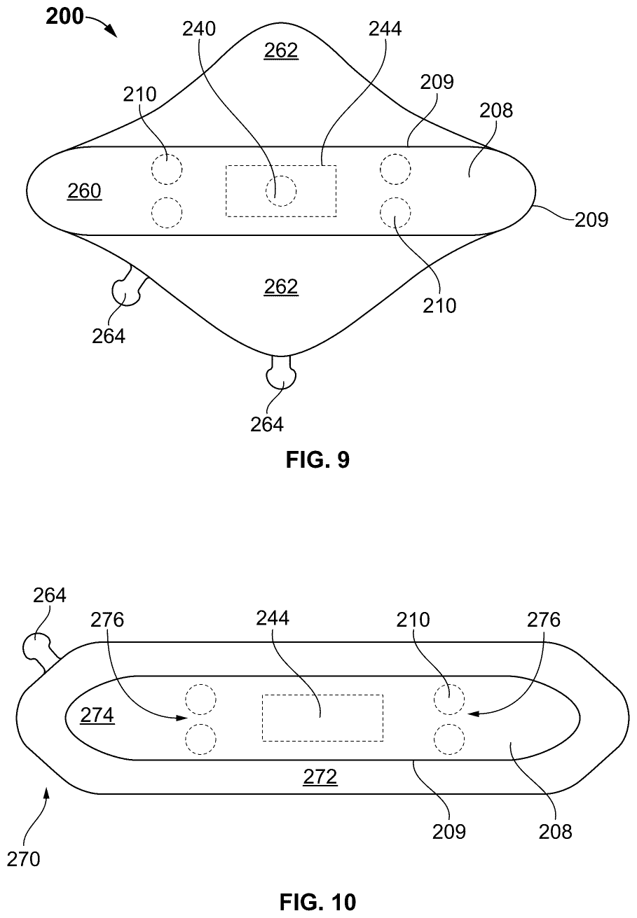

FIG. 9 depicts schematically a top view of an embodiment of an illumination device 200 in accordance with the invention. As depicted, illumination device 200 comprises a pad 208 having a pad periphery 209, a plurality of LED light sources 210, a power source 240 integral in pad 208, an electronic control circuit 244 integral in said pad 208, and an exterior surface 260. Device 200 also includes manual switching means (similar to switching means 116 in FIG. 6) for electrically connecting power source 260, control region 244 and light sources 210. Device 200 further includes an adhesive film 262 operable to adhere said pad 208 to a substantially transparent sidewall of a beverage container in a substantially liquid-tight manner. As depicted in FIG. 9, adhesive film 262 extends laterally from a portion of pad periphery 209. Device 200 also includes at least one non-adhesive tab 264 attached to said adhesive film 262 for removing said device from a sidewall of a beverage container.

FIG. 10 depicts schematically a bottom view of an embodiment of an illumination device 270 in accordance with the invention. Illumination device 270 is similar to illumination device 200 of FIG. 9 except that illumination device 270 comprises an adhesive film 272 that extends laterally from substantially all of periphery 209. Interior surface 274 of pad 208 includes a lighting area 276 from which light sources 210 are operable to emit light.

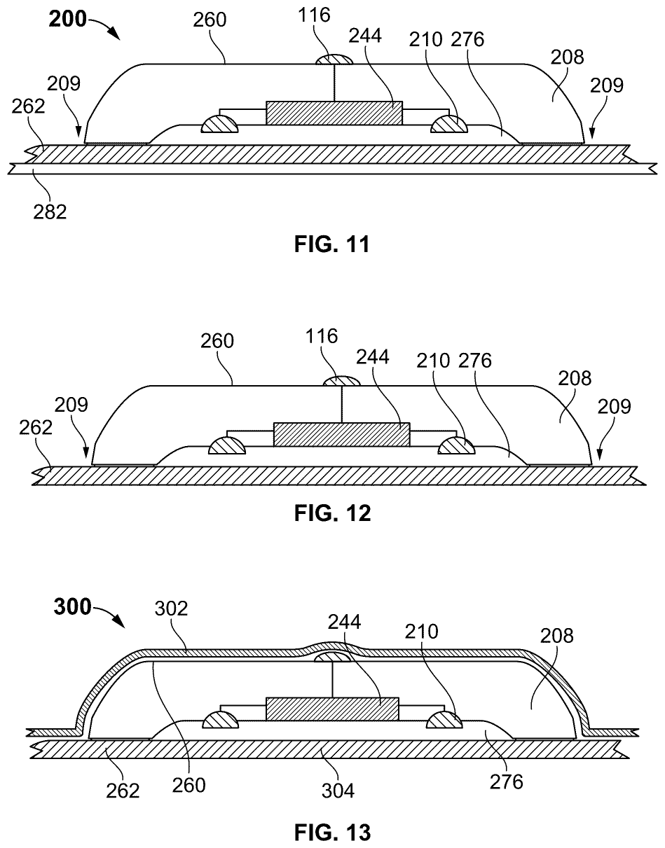

FIG. 11 depicts schematically a cross-sectional view of an embodiment of an illumination device 200 in accordance with the invention. As depicted, illumination device 200 comprises a pad 208 having a pad periphery 209, a plurality of LED light sources 210, a power source (not shown) integral in pad 208, an electronic control circuit 244 integral in said pad 208, and an exterior surface 260. Device 200 also includes manual switching means 116 for electrically connecting the power source, control region 244 and light sources 210. Device 200 further includes a bottom adhesive film 262 operable to adhere said pad 208 to a substantially transparent sidewall of a beverage container in a substantially liquid-tight manner. The interior surface of pad 208 includes a lighting area 276 from which light sources 210 are operable to emit light.

As depicted in FIG. 9, bottom adhesive film 272 extends laterally from pad periphery 209. Device 200 also includes a removable protective film 282 that protects bottom adhesive film 272 before adhesion of said pad 108 onto a substantially transparent sidewall.

FIG. 12 depicts schematically a cross-sectional view of illumination device 200 as in FIG. 11 after protective film 282 has been removed prior to adhesion of illumination device 200 onto a beverage container.

FIG. 13 depicts schematically a cross-sectional view of illumination device 300 in accordance with the invention. Illumination device 300 is substantially similar to illumination device 200 as described with reference to FIGS. 11 and 12 except that illumination device 300 also includes a top cover film 302 that covers pad 208. Typically, top cover film has an adhesive bottom surface that adheres top cover film 302 to exterior top surface 260 of pad 208. Preferably, top cover film 302 comprises water-tight material and completely covers exterior surface 260 of pad 208. As depicted in FIG. 13, top cover film 302 and bottom adhesive film 282 together form a water-tight envelope in which pad 208 is located and protected. Of course, bottom adhesive film 282 is translucent, preferably transparent, at least at its light transmission area 304 beneath lighting area 276.

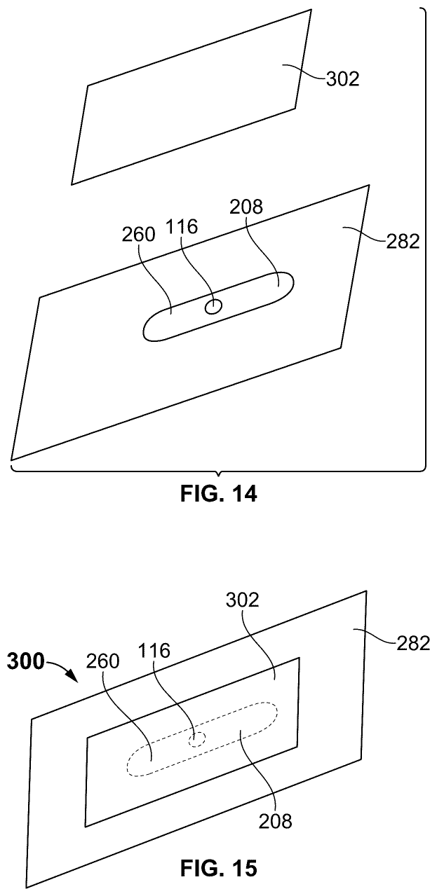

FIG. 14 depicts schematically some of the principal components suitable for assembling illumination device 300 in accordance with the invention. In FIG. 14, pad 208 is located with its exterior top surface 260 and manual switching means 116 facing up on the top of bottom adhesive film 282. Top cover film 302 is depicted separately above pad 208. FIG. 15 depicts schematically illumination device 300 in accordance with the invention after top cover film 302 has been attached to cover pad 208.

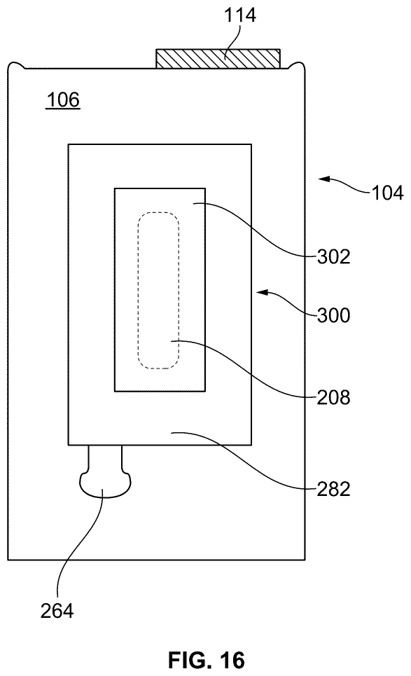

FIG. 16 depicts schematically a self-contained illumination device 300 attached to a beverage container 104 having a substantially transparent sidewall 106. Illumination device 300 comprises a pad 208, a bottom adhesive film 282, a top cover film 302, and a non-adhesive tab 264 for removing device 300 from sidewall 106 of beverage container 104.

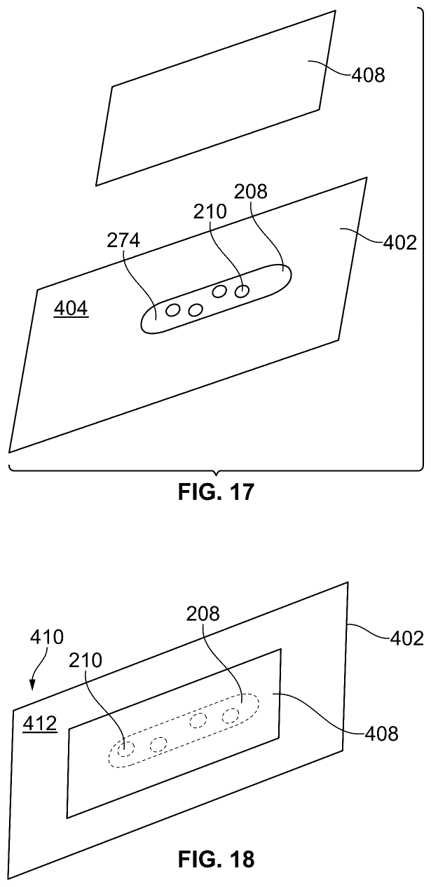

As can be understood from this specification, an illumination device in accordance with the invention can be designed and assembled in many variations. For example, FIG. 17 depicts schematically the principal components suitable for assembling an illumination device that comprises a top adhesive film 402 having a bottom adhesive surface 404 that covers and attaches to pad 208. In FIG. 17, the bottom, interior surface 274 of pad 208 is depicted along with light sources 210. FIG. 17 also depicts bottom cover film 408, which is designed to cover interior surface 274 of pad 208 as well as to adhere to bottom adhesive surface 404 of top adhesive film 402.

FIG. 18 depicts schematically illumination device 410 in accordance with the invention after top adhesive film 402 having a bottom adhesive surface 404 has been attached to bottom cover film 408, resulting in formation of a protective envelope containing pad 208. The adhesive peripheral area 412 extending beyond the peripheries of bottom cover film 408 and of pad 208 serve to attach device 410 to the wall of a container. Bottom cover film is translucent, preferably transparent, at least in areas below the light sources in pad 208.

The particular systems, devices and methods described herein are intended to illustrate the functionality and versatility of the invention but should not be construed to be limited to those particular embodiments. It is evident that those skilled in the art may now make numerous uses and modifications of the specific embodiments described, without departing from the inventive concepts. It is also evident that the steps recited may, in some instances, be performed in a different order; or equivalent structures and processes may be substituted for the structures and processes described. Since certain changes may be made in the above systems and methods without departing from the scope of the invention, it is intended that all subject matter contained in the above description or shown in the accompanying drawings be interpreted as illustrative and not in a limiting sense. Consequently, the invention is to be construed as embracing each and every novel feature and novel combination of features present in or inherently possessed by the systems, materials, devices and methods described in the claims below and by their equivalents.

What is claimed:

1. A self-contained illumination device for illuminating liquid contents of a beverage container having a substantially translucent sidewall, comprising:
a pad;
a control circuit;
a power source connectable to said control circuit; and a
a plurality of light sources connectable to said control circuit;
wherein said control circuit and said lighting sources are attached to said pad;
wherein said pad comprises an exterior surface, a circuit region containing said control circuit, and an adhering surface, said adhering surface having a plurality of light areas and an adhesive region substantially surrounding said light areas;
wherein said pad comprises liquid-impervious material;
wherein said control circuit is connectable to said light sources and said power source; and
wherein said adhesive region is operable to adhere said pad to a substantially translucent sidewall of a beverage container in a substantially liquid-tight manner.

2. A device as in claim 1 wherein said pad is flexible.

3. A device as in claim 1 wherein said pad has a thickness in a range of about 1 mm to 5 mm.

4. A device as in claim 1, further comprising:
a plurality of control circuits, each of said control circuits comprising a printed circuit board;
wherein at least one of said control circuits is connectable to a plurality of light sources.

5. A device as in claim 4 wherein;
a plurality of light sources are LED lights; and
at least one control circuit is operable to control a plurality of said light sources to generate light of different colors.

6. A device as in claim 4 wherein at least one control circuit is operable to control a plurality of said light sources to generate blinking light of different colors.

7. A device as in claim 1, further comprising:
a manually operable switching means accessible on said exterior surface operable to connect electrically said control circuit, said power source and said light sources.

8. A device as in claim 1, further comprising:
printable material located in said circuit region, said printable material comprising at least one printed circuit board.

9. A device as in claim 1 wherein said pad has an elongated shape and is operable to adhere to said substantially translucent sidewall in a substantially vertical orientation relative to an upright beverage container.

10. A device as in claim 1 wherein said pad has an elongated shape and is operable to adhere to said substantially translucent sidewall in a substantially horizontal orientation relative to an upright beverage container.

11. A device as in claim 1 wherein said device is sized and shaped to reside substantially within a convex recess in a substantially translucent side wall of a beverage container.

12. The combination comprising:
a beverage container having a substantially translucent side wall; and
an illumination device for illuminating liquid contents of said beverage container;
wherein said illumination device is designed to adhere to a substantially translucent side wall of said beverage container.

13. A device as in claim 12 wherein:
said substantially translucent side wall has a convex recess; and
said device is sized and shaped to reside substantially within said convex recess.

14. A device as in claim 13 wherein:
said convex recess has a substantially vertical orientation relative to an upright beverage container.

15. A device as in claim 13 wherein:
said convex recess has a substantially horizontal orientation relative to an upright beverage container.

16. A self-contained illumination device for illuminating liquid contents of a beverage container having a substantially translucent sidewall, comprising:
a pad having a pad periphery;
a control circuit;
a power source connectable to said control circuit;
a plurality of light sources connectable to said control circuit; and a
an adhesive film extending laterally outwards from at least a portion of said pad periphery;
wherein said power source, said control circuit and said lighting sources are attached to said pad;
wherein said pad comprises an exterior surface, a circuit region containing said control circuit, and an interior surface, said interior surface having at least one interior lighting area;
wherein said light sources are operable to emit light from said interior lighting area;
wherein said pad comprises liquid-impervious material;
wherein said control circuit is connectable to said light sources and said power source; and
wherein said adhesive film is operable to adhere said pad to a substantially translucent sidewall of a beverage container in a substantially liquid-tight manner.

17. A device as in claim 16, further comprising:
a plurality of control circuits, each of said control circuits comprising a printed circuit board;
wherein at least one of said control circuits is connectable to a plurality of light sources.

18. A device as in claim 16 wherein:
a plurality of light sources are LED lights; and
at least one control circuit is operable to control a plurality of said light sources to generate light of different colors.

19. A device as in claim 18 wherein at least one control circuit is operable to control a plurality of said light sources to generate blinking light of different colors.
